(19) United States
(12) Patent Application Publication
(10) Pub. No.: US 2015/0095146 A1
(43) Pub. Date: Apr. 2, 2015

(54) SMART ANALYTICS FOR AUDIENCE-APPROPRIATE COMMERCIAL MESSAGING

(71) Applicant: Brighterion, Inc., San Francisco, CA (US)

(72) Inventor: Akli Adjaoute, Mill Valley, CA (US)

(73) Assignee: BRIGHTERION, INC., San Francisco, CA (US)

(21) Appl. No.: 14/243,097

(22) Filed: Apr. 2, 2014

(51) Int. Cl. G06Q 30/02

(52) U.S. Cl. CPC G06Q 30/0269; G06Q 30/0255; G06Q 30/0276
USPC 705/14.53; 705/14.66

(57) ABSTRACT

A real-time fraud prevention system enables merchants and commercial organizations on-line to assess and protect themselves from high-risk users. A centralized database is configured to build and store dossiers of user devices and behaviors collected from subscriber websites in real-time. Real, low-risk users have webpage click navigation behaviors that are assumed to be very different than those of fraudsters. Individual user devices are distinguished from others by hundreds of points of user-device configuration data each independently maintains. A client agent provokes user devices to volunteer configuration data when a user visits respective webpages at independent websites. A collection of comprehensive dossiers of user devices is organized by their identifying information, and used calculating a fraud score in real-time. Each corresponding website is thereby assisted in deciding whether to allow a proposed transaction to be concluded with the particular user and their device.

### BACKGROUND OF THE INVENTION

1. Field of the Invention

The present invention relates to automated systems for understanding customer needs from their online behaviors, and more particularly to software-as-a-service merchant systems able to formulate suitable commercial messages and offers to merchants' customers.

2. Background

Commercial messages that have no relevance or importance to a consumer are easy for them to ignore and dismiss. Do it enough, and the consumers will get annoyed by the noise. Consumers have learned to tune out when they have been bombarded with rudderless billboards, letters, radio and TV spots, and now emails and pop ups on webpages. Very rarely does something interesting or relevant present itself, and those that do get tossed out with the ad hoc spam filters we all create.

People generally behave in consistent ways that make their future behaviors predictable, at least to some extent. Consumer behavior and predictions are bit easier to observe and to forecast because sales data is very objective. Messages generated from these observations and forecasts would also be better received since they would be more businesslike and less personal. Insulting, embarrassing, and intimidating messages will, of course, completely turn off anyone, so messages that could have these affects are to be scrupulously avoided if one hopes to succeed in a line of business.

### SUMMARY OF THE INVENTION

Briefly, a commercial messaging embodiment of the present invention is implemented as a software-as-a-service (SaaS) application on a network server. Clickstream behaviors collected while consumers are online shopping or surfing are copied to the SaaS from the websites they are visiting. Individual words in the clickstreams are highly ambiguous and specific meanings for them are calculated by analyzing the contexts in which they exist. Context vectors and weights are assigned to resolve word ambiguities. The points of interest for the consumer are revealed and are used as a template to screen through appropriate commercial messages given the individual consumers' apparent shopping interests. A diverse kit of commercial messages are sold to and subscribed by a wide variety of commercial producers of products and services. These commercial producers will pay a premium for SaaS services that can effectively deliver a relevant audience.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is functional block diagram of a computer program product for centralized hosting of business applications as a software-as-a-service (SaaS) product installed on a payments processor;

FIG. 2 is a flowchart diagram of a top level computer process useful in the SaaS product of FIG. 1;

FIG. 3 is a flowchart diagram of how user devices can be accurately categorized by a five-layer identification process that includes endpoint, navigation, single-channel, multi-channel, and entity link analyses;

FIG. 4 is a flowchart diagram of how the word contexts in webpages can be artificially understood and worked with by a computing machine; and

FIG. 5 is a graphical diagram of a two-dimensional user behavior space, and is representative of a multi-dimensional user behavior space that would be practical and affordable to construct with conventional technologies and networks.

### DETAILED DESCRIPTION OF THE INVENTION

In general, commercial messaging embodiments of the present invention are implemented as a software-as-a-service (SaaS) applications on network servers. The clickstream behaviors of online consumers are collected in real-time while the consumers are online shopping or surfing. The clickstream behaviors are copied to the SaaS from the visited websites that subscribe to such service.

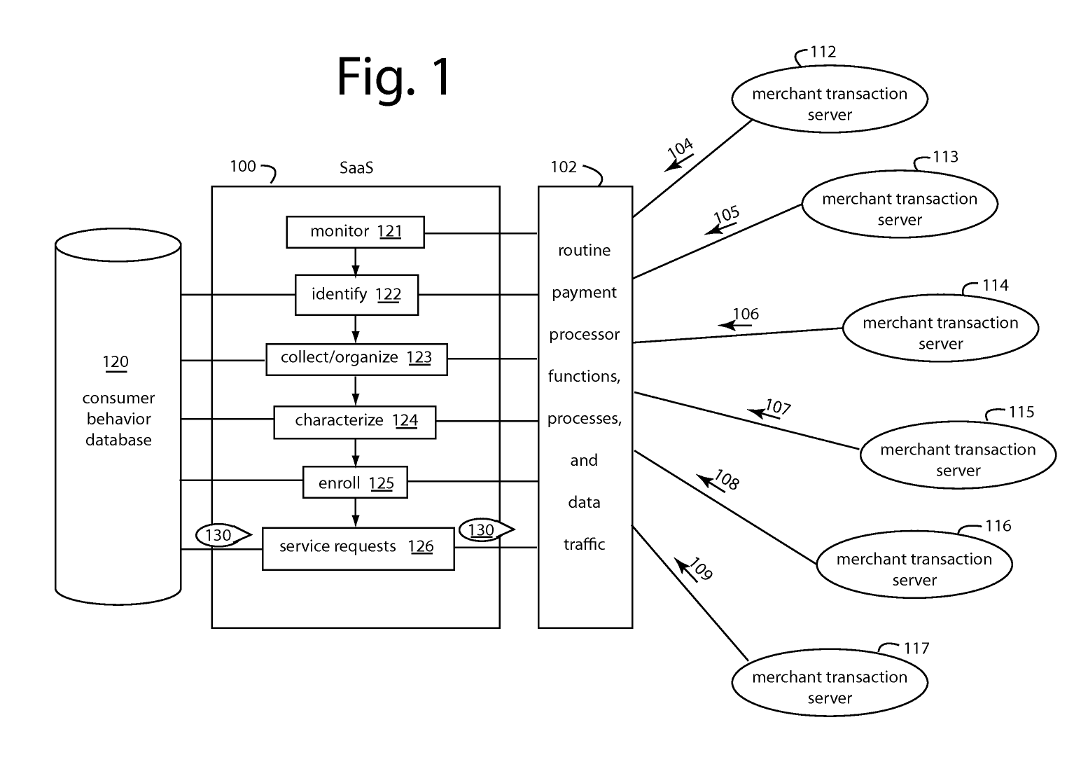

Referring now to FIG. 1, a software-as-a-service (SaaS) 100 is built to run as an application on a network server 102. Clickstream behavior data 104-109 corresponding to numerous online consumers are collected in real-time while the consumers are online shopping or surfing at a variety of independent and unrelated commercial websites. Each of these commercial websites has its own merchant transaction server 112-117 that is extended to accumulate and forward clickstream such behavior data. The clickstream behaviors 104-109 are copied to the SaaS 100 from the visited websites that subscribe to such service. The context for ads can be used to identify specific audiences). For example, an ad for a hotel can be offered for display if the user context is travel. However, an ad for wine is not appropriate on a website for recovering alcoholics, even though the ad and the content of the website are related to the context (albeit in a negative way). The context and the positive direction of the context is to be understood to make for an effective SaaS service.

A Thesaurus-based contextual analysis can be used to filter the content. e.g., extracting the main idea of the content by determining the contexts in which words in the content are used. A thesaurus is built into word-context database and stored in database 120.

Contextual analysis is used in embodiments of the present invention to evaluate the appropriateness of a particular site, so the main idea of the site's content can be extracted. The information extraction is a text process that locates a specific set of relevant items in the web page document.

Contextual analysis and concept extraction can automate a categorization and cross-referencing of information by using the thesaurus. By using contextual analysis, smart analytics processors can artificially “understand” the main idea of most documents and websites. Smart analytics assigns the highest importance to semantics and each word's context or main idea.

Smart analytical software is best installed on a central server to monitor the activities of a large population of users. The thesaurus database is loaded with an extensive list of words and an comprehensive list of contexts in which such words are typically used. The thesaurus database helps create a list of contexts for the relevant words visited in a document. When the document is an electronic webpage, included software follows any links displayed in the web page to further detail the contexts.

The smart analytical software assigns a “context pertinence value” to each context found in the document. The context pertinence value of a given context determines how many restricted words associated with that context are found in the document. The smart analytical software determines the most important contexts conveyed in the electronic document. Each word is assigned a weight that depends on how the word is displayed in the document. Each context is assigned a weight that depends on the number of words in the document that have the same context, the weight of those words, and the number of contexts for each one of those words. The contexts assigned the highest weight are determined to be the most important contexts. If the most important contexts are among the restricted contexts specified in the contexts database, the user is offered ads specific to that context.

As seen in FIG. 1, SaaS 100 comprises software instruction sets 121-126 for enabling payments processor network server 102 to additionally provide consumer preferences and forecasts, or even audience-appropriate commercial messages 130 to what can be thousands of merchant transaction processors 112-117. For example, using the contextual analysis detailed herein.

Software instruction set 121 monitors consumer purchase transaction and payment data independently communicated with individual merchant transaction servers and a payments processor server. Excerpts and abstracts of these are stored in a database 120.

Software instruction set 122 identifies individual consumers from many instances of consumer purchase transaction and payment data coming over time over many unrelated connections to independent merchant transaction servers. The identifications are stored in database 120.

Software instruction set 123 collects and organizes consumer purchase information derived from the transaction and payment data according to the consumer identities recognized. The organized collections are stored as dossiers in database 120.

Software instruction set 124 characterizes what is important to each identified consumer and forecasts what they are likely to buy from intimations obtainable from records of what they did buy, when they bought it, what was bought in combination, where it was bought, what the total purchases were, and any strong correlations to other available data. These conclusions, consumer preferences and forecasts 110 are kept at-the-ready in database 120.

Software instruction set 125 enrolls individual ones of many merchant transaction servers connected to the payments processor server to access conclusions calculated as to what is important to each identified consumer and forecasts of what they are likely to buy. Those enrolled are maintained in database 120.

Software instruction set 126 enables payments processor server 128 to service real-time requests by enrolled ones of the merchant transaction servers for the conclusions that have been calculated. In response, database 120 supplies individual consumer preferences and forecasts 110. The enrolled ones of the merchant transaction servers 112-117 are enabled by the conclusions to offer messages and incentives of interest to a correspondingly identified consumer at the time of their concluding another transaction with a merchant.

Device identifications that use behavioral data to advance over simple device ID techniques will outperform and provide better results and lowered losses due to fraud. Behaviorally enhanced device ID is therefore a critical part of all embodiments of the present invention. It recognizes individual users will use their tools in repeatable, recognizable ways no matter what devices they are using at the moment.

It is important for merchant companies to constantly evolve their systems to stay in tune with developing standards, rapid technological changes, and keep up with ever more sophisticated and capable fraudsters trying to break in and abuse their systems.

Very few single dimension device ID technologies are effective in being able to uniquely recognize devices when the legitimate devices themselves are changing daily. Multi-layer, multi-dimensional fraud device identification is required now in a world where ever-more clever thieves and surprising new malware behaviors pop up daily.

In general, multi-layer behavioral device identifications can be had by combining multi-agent technology with case-based reasoning, real-time profiling, and long-term profiling. Multi-layer behavioral device identifications can guarantee correct device identifications even when many changes and updates have occurred on the devices. Better device identifications mean e-commerce can be safer and more secure for everyone.

Smart-agents are used in the embodiments of the present invention to create a virtual agent for each user device. Each such virtual agent is configured to observe and learn the behavior of its host user device over time to create a device profile. The ways the user device is used, the frequency of its use, the types of actions taken, e.g., during the last minute, ten minutes, over days/weeks/years are all intelligently aggregated into a profile of what's normal for this user.

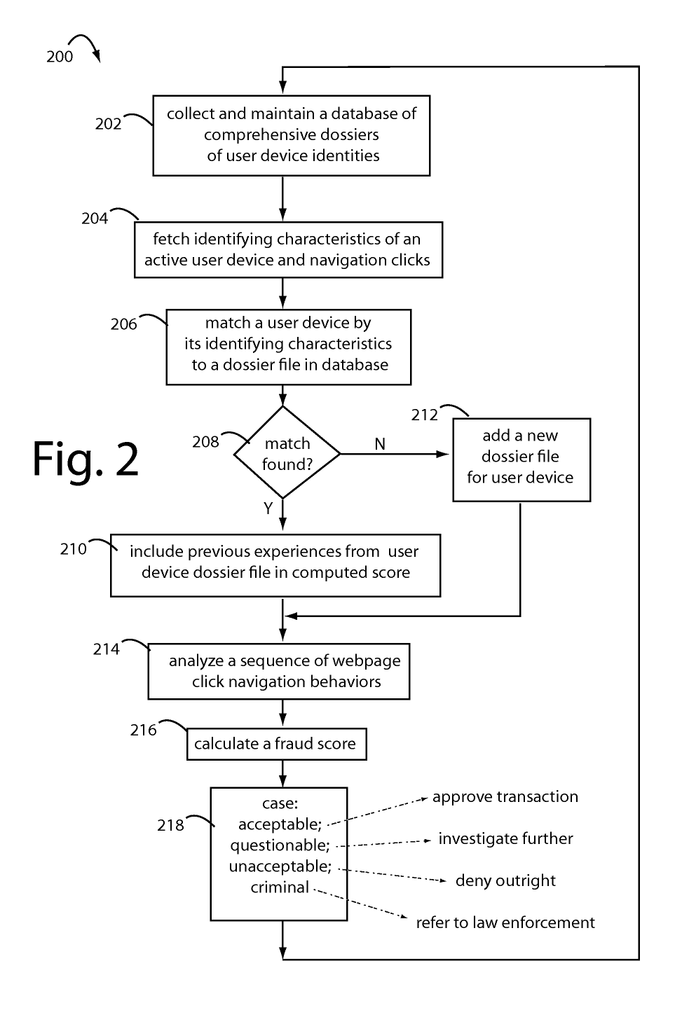

FIG. 2 represents a network server method 200 for protecting websites from fraudsters. Method 200 includes a step 202 for accumulating and maintaining a database of comprehensive dossiers of user device identities. These identifying characteristics are fetched in a step 204 from activity reports about user-device visits to webpages as they are volunteered by the reporting websites. The assemblage and organization of user device identifying characteristics can be carried on over a period of time that can span months or even years. A step 206 tries to match each newly presenting user device currently visiting a website by its identifying characteristics to a particular user device identity dossier already in the database 120.

If a match is found in a step 208, any previous experiences with the particular user device by this or other included websites is included in a first part calculation of a fraud score. Such first part of the score is computed in a step 210. Otherwise, a step 212 builds and adds a new file to be inserted the database 120 for future use.

A step 214 analyzes a sequence of webpage click navigation behaviors of each corresponding user device then being employed to visit a particular webpage and website. A real person with a real purpose will navigate around and between webpages in a particular way. Fraudsters and automated crawlers behave very differently. A step 216 calculates a final or only part of the fraud score in real-time. A step 218 is configured as an output which useful to assist each website in determining whether to allow a proposed transaction to be concluded by a particular user device. For example, a good score predetermined to be acceptable would trigger an approval of a user transaction. A marginal score could be used to signal a call should be made, or investigated further. A poor score would issue an outright denial. A red-flag score could be used to alert law enforcement.

Whenever a particular user device cannot be matched to any particular dossier file in the database, a new dossier file is opened up for such user device according to the user device identification parameters then obtained. The determination of a fraud score is necessarily limited to what can be surmised by analyzing the sequences of webpage click navigation behaviors that occurred. This limitation is reflected in the fraud score.

An endpoint client can be embedded in a webpage presented on a website and configured to provoke a browser in a user device to report back user device information, capabilities, extensions, add-ons, configurations, user device locations, and other data which are useful to sort through and contribute to corresponding user device dossier files maintained in the database 120. For example, FLASH PLAYER video, ACTIVEX, and JAVASCRIPT objects embedded in webpages all naturally provoke a lot of useful identifying and characterizing information to be reported back from plug-ins and extensions already present each user device.

For example, JavaScript can be used to check various non-universal physical attributes of a particular user device, including its operating system, CPU architecture, video card, screen size, and other items that fluctuate widely in the real-world population. The data that can usually be obtained by JavaScript includes, user agent, Screen resolution, user language, time zone offset, graphics processing unit (GPU) information, list of specific fonts availability, list of plugins, list of MimeTypes, availability of cookies, availability of HTML5 properties and methods, attributes specific to the browser, etc.

If an innocuously small Flash video is included in the webpages, its normal protocols can be appropriated to provide extra information made available to the Flash player, e.g., information describing audio/video codecs, printers, touchscreens, and other peripherals. The physical location of a user device can be discerned from its IP address using a geo-location database to get the city, latitude, and longitude. Overall, two hundred fields can be gathered together and used to identify a single user device with high degree confidence.

A mobile endpoint client is similar to the endpoint clients used for personal computers. It may not always be possible to gather identifying user device information with a browser. So mobile endpoint clients are constructed from small libraries of Java (for Android) or Objective C (for iOS) and included in a downloadable app. Once installed, the app is empowered to request a device ID from the mobile client. It is configured to gather user device information in the background and send it to server 128 for recognition and identification.

An unnoticeable web browser is launched in the background to gather data from various browser-specific fields. Running now as an application, all the system calls become available. These system calls can be used to retrieve the peculiar mobile user device's physical properties, e.g., the iOS/Android version, the size and resolution of the screen, the capabilities of the touchscreen, etc. The user's settings can also be accessed, as well as a list of all the apps then installed on this particular user device. All this information is useful in database 120 to characterize and distinguish the particular user device 120-122 from a million others.

Using IP addresses for geo-location is not entirely satisfactory, these can vary as a user moves around from one cell tower to the next or between WiFi routers. It's better to use the built-in GPS app if available. Most smartphones now include these in their standard kit.

A centralizing of the collecting and maintaining of a database of comprehensive dossiers of user device ID's allows for a much larger population to be obtained from countless user-device visits to numerous webpages maintained by many unrelated websites. The otherwise independent and unrelated websites each forward user device activity reports in real-time as they occur to a single centralized server 128 that solely controls and maintains database 120. Fraud scores are reported back to the corresponding websites, e.g., over the Internet. Such service can be by paid subscription. Embodiments of the present invention would be useful in commercial payment systems, peer-to-peer money transactions, physical access controls to buildings and other facilities, communication-command-control applications, and in sensitive document control.

In general, embodiments of the present invention protect websites from fraudsters by analyzing webpage click navigation behaviors each of device visiting their webpages, and by collecting and maintaining comprehensive dossiers of device ID's, and by producing a fraud score in real-time to assist the website in deciding whether to allow a proposed transaction to be concluded.

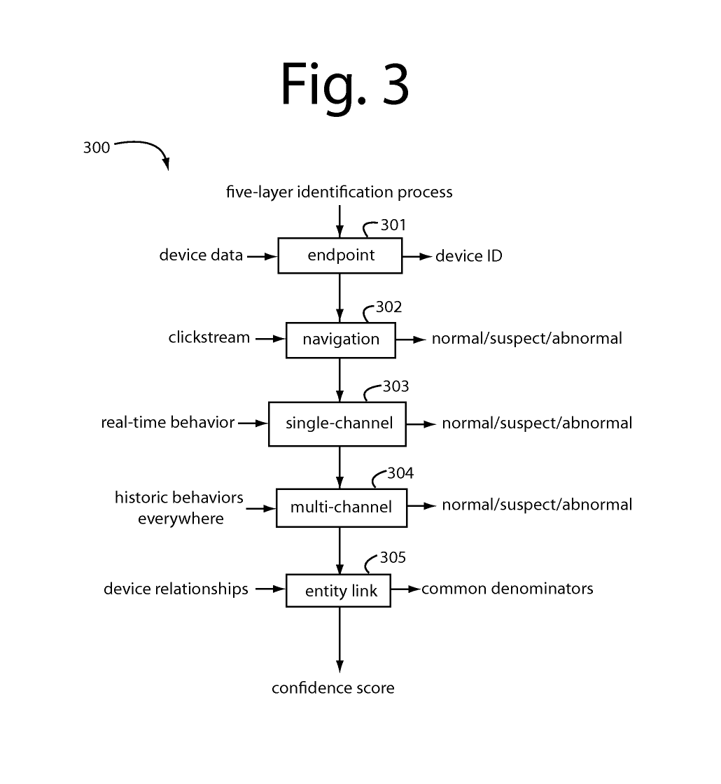

FIG. 3 represents how user devices can be accurately classified and categorized by a five-layer identification process 300 that includes endpoint 301, navigation 302, single-channel 303, multi-channel 304, and entity link 305 analyses. The first classification layer 301 is endpoint-centric, it identifies users by their behaviors and by the attribute signatures of their particular devices. Such attribute signatures can be extracted by their browsers and the information obtained used in the identification.

An endpoint client is embedded in a web page provided by a website server so it can be carried back to the user device by its browser and run in background to gather data. When the data collection is completed, the endpoint client automatically delivers the collected data up to the website server for immediate use in identifying this user device.

Smart-agent technology, data-mining, a decision tree, and case-based reasoning are all used to find candidate matches in a large, server-side database. Such will either find a matching device or the collected data will be used to create a new device dossier. If the user device was recognized, the data fields in its dossier are updated as needed.

Mobile devices have a variety of ID's built-in, some incidentally and others unintended. For example, the Android ID is randomly generated and will persist across phone resets. The SIM cards used universally by mobile providers in their phones provide unique identifiers, but these cards can be freely removed and plugged into another phone by any user. There are other inherent ID's that are less reliable for our purposes, but these nevertheless can be helpful to build confidence.

The navigation-centric layer is the second layer mentioned. It is used to track session activities and do a clickstream analysis in real-time. The user's clickstream behaviors are compared to previously observed patterns of normal, suspect, abnormal, and malware attack activities for this particular user and the population in general. Smart-Agents are used in these categorizations.

Clickstreams are the navigation pathways users follow through web pages and can be tracked by the webpage servers. The order of the pages a user views can be and which pages they visit can be quite telling and uncover their true motivations in the visit. An important conclusion can be made as to whether this is a real customer legitimately engaged in shopping or a fraudster bouncing around looking for a point of entry. Once the current user has been identified, a record of their navigation clicks is constructed and used in a behavior study to build a confidence score.

One way to follow a user's path through a web site is to look first at the Referrer header for each page, e.g., to see where they came from. It can be informative to know if they arrived here from a search engine, from a competitor, from another one of the server's pages, or if they just typed the URL straight into their browser.

A “site depth” is assigned to each web page to represent how far or how many clicks away it is from the home page. These statistics can be used to see if the visitor is convincingly browsing around and up/down a product tree like a real user would.

Velocity counters track how fast a visitor is moving around in several dimensions, such as their reputed location, times of day, clickstreams, items added to carts, number and length of browsing sessions, click rates and quantities, category changes, reviews read, etc. For example, if a review is read for a product before buying it. Another important visitor attribute to recognize is the number of category changes they make as they navigate. Typical users usually have a single product goal in mind, they don't bounce randomly between categories nor shop for two or more items simultaneously.

Suspicious browsing patterns are often generated by automated site-crawling scripts. Long-term profiling counters are useful to track the number of different products users have viewed or purchased in each category. The average prices and numbers of items per order are also useful points to remember. Big ticket buyers don't randomly drop from the sky unannounced. Tracking what cities and countries a user logs in from, and what local times of day they have been active can be used to distinguish legitimate users. A lot of fraud is generated from Eastern Europe, Asia, and Africa, and so those sources deserve extra scrutiny and wariness.

Any new behavior raises a red-flag and can be used to match the historical actions on file. If a legitimate user were to leave their account logged in and a stranger sat down, or if an account is stolen with fraud or malware, the new behavior outside historical actions would be an early warning of fraud.

The third layer, is account-centric for a specific channel, such as online sales. It monitors transactions, creates profiles associated with each user device and analyzes real-time behavior. A combination of technologies are employed, e.g., smart-agent, real-time profiling, geo-profiling, recursive profiling, long-term profiling, neural networks, data mining, data quality engine, fuzzy logic, business rules, and case-based reasoning.

The fourth layer is device-centric, with behavioral perspectives taken across multiple channels of user device contact with independent merchant servers. The device-centric layer correlates alerts and activities for each device/user obtained from more than one channel.

Layer five includes entity link analysis, it searches for relationships among the devices they encounter and the channels they employ. The entity link analysis layer inspects users and machines in an effort designed to detect organized criminal activities and misuse. For example, all devices of a device or type should be or could expected to be similarly affected by WINDOWS, ANDROID, or iOS system updates, patches, and new versions that occur in public and more or less around the same time. These broad transformations in the population can be used in the scoring of changes as normal/abnormal when identifying a particular user device.

Each of the five layers 301-305 can by implemented with Smart-Agents that interact and negotiate with each other in order to reach their individual and collective goals. Algorithmic systems are very different and produce less reliable results in fraud risk assessments. Smart-Agents determine how to find a solution by providing each agent with goal information, e.g., situations that are desirable or undesirable.

Smart-Agents solve problems without needing extensive programming or sets of specific rules to be predefined that make for inflexibilities common to neural networks and genetic programming. Smart-Agents are able to effectuate runtime changes and adapt as needed.

Algorithmic programs follow successive operations applied in a fixed order. Algorithms enable computers to repeat long suites of logical operations tirelessly and accurately, which is great if the algorithm is fundamentally correct. Algorithmic programs are not equipped to take any initiative, and cannot stray even a little bit from each fixed line of code. It falls on the programmer to dictate, and spell out a precise succession of acts that the machine should follow. Often, there are just too many variables to code and too many decisions that can each be wrong. Business problems requiring even a minimum amount of reasoning are impossible to transcribe into algorithmic forms. Business decisions often require complex integration efforts involving large numbers of dynamic variables. And, having an algorithm available doesn't guarantee its practicality. Modest complexities can make it unwieldy.

Neural networks are not much better, they need to be trained, and many samples are needed in order to have a satisfactory result. Object-oriented languages require one to foresee, know, and program all the possible methods.

Smart-Agents can get past algorithmic limitations, and it is possible to design applications for them even when a suitable algorithm is unknown. Smart-Agents can adapt as the data they process changes. Each Smart-Agent is instructed to recognize information that favors the goals and is therefore “good”, and information that disfavors the goals and is therefore “bad”. Such instructions enable each Smart-Agent to automatically and autonomously make the “right” decision. This right-decision is referred to as the “THEN STATEMENT”, as in a classic IF-THEN programming statement. An optimum THEN STATEMENT is relatively easy for a programmer to coin and get right.

The intelligence in the program springs from what the programmer embeds in each THEN STATEMENT. Smart-Agents can exist in a community of agents collected together to share a particular expertise, mimicking human society as they do. Smart-Agents can simulate human reasoning. Each Smart-Agent is able to operate independently according to its assigned functions, goals, representations of their environments, their runtime observations, acquired knowledge and interactions with other Smart-Agents. Systems of Smart-Agents marshal together many autonomous agents to interact and negotiate with one another.

An application's overall solution builds from the interactions as each Smart-Agent moves toward their respective goals.

Collections of Smart-Agents will appear to interact and negotiate to resolve complex and unpredictable problems, without any procedural programming or definition of rules. Each Smart-Agent is independent of the others, since each one of them only affects the others by the fact that they are in favor or disfavor of a specific goal. Smart-Agents are reusable in other applications.

Goal-satisfaction mechanisms direct Smart-Agents to accept or reject one incoming message over another. Every message is evaluated in terms of its being in favor of, in disfavor with, or neutral to reaching of a goal. For example, a private goal, a sending agent's goal, an organization's goal, or a system's goal. The Smart-Agents depend on each goal's opinion with respect to the current situation, the goal justifies the means. Smart-Agents can refuse messages, because they can charge messages as being favorable, unfavorable or neutral.

A bottom-line in fraud prevention systems is to decide how a particular transaction should be categorized. Every transaction is accepted by either a bad (fraud) agent or a good (normal) agent.

Other technologies can be usefully combined with Smart-Agents to produce even better results. Neural networks are a kind of algorithmic system that can interpret historical data and help identify trends and patterns against which to compare subject cases. Neural networks have the remarkable ability to solve problems related to detecting trends and patterns that humans or other computer techniques are unable to solve.

An Artificial Neural Network (ANN) models the ways in which biological nervous systems process information. The brain, e.g., consists of billions of processors, which process a large number of tasks concurrently. Neurons work collaboratively to solve the defined problem. Neural networks can resemble human reasoning, making them well suited to solve pattern recognition and forecasting problems.

ANN's have two primary parts, neurons, represented by neural units; and, synapses, connections between the neurons, which send signals from neuron to neuron. Those synapses can be excited (positive weight), or inhibited (negative weight). Most known neural networks have input layers for the agent to receive data from the environment, and output layers for the agent's potential actions. Others (like Back Propagation) have one or more intermediate layers between these two layers. These layers are massively interconnected, as the units on one layer are connected to those in the next layer. Just like the factors that shape a human, the factors that shape a neural network are its environment and its genetic makeup. Both its initial state and its training play a role in the ANN's development. It is through the critical training process that ANN's are taught how to arrive at the correct answer. A well-trained neural network will be more successful than a poorly trained neural network. The training refers to its environment and the experiences and samples that help shape it. The more samples and experience a neural network receives has a direct correlation with its likelihood of its success.

Case-based reasoning (CBR) can use past experiences or cases to solve new problems. Each “case” is translated into a list of steps to lead to a desirable outcome. The cases are stored and organized in a database, and used as an index for similar situations later. Solutions to complex problems can be found very quickly and accurately this way.

Being able to retrieve and manipulate past problem-solving examples accurately is important. Case-based systems search their case memories for an existing cases that match the input “specifications”. As new cases are solved, the solutions are added to the case memory. Such will continue to grow the database of cases solved and increase the likelihood of success.

The goal is to find a case that matches the input problem and that proceeds directly to a solution. Thus making it possible to provide solutions to potentially complex problems quickly. If, on the other hand, an exact match cannot be found, the case-based system look for a similar one to the input situation, and then offer it as a potential solution.

How the system learns is when a nonperfect match is found that nevertheless solves the problem, the case is added to the systems case memory for future use. Each case is a recipe of steps that will lead to a particular outcome. A case is a connected set of subcases that form the problem-solving task's structure.

One of the key differences between rule-based and case-based knowledge engineering is that automatic case-indexing techniques drastically reduce the need to extract and structure specific rule-like knowledge from an expert. CBR systems retrieve relevant cases quickly and accurately from its memory. When a case should be selected for retrieval in similar future situations is the goal of case-indexing processes. As cases accumulate, case generalizations can be used to define prototypical cases that can be stored with the specific cases, improving the accuracy of the system in the long run.

The inductive-indexing capabilities in CBR systems provide several major advantages over neural networks and pattern-recognition techniques. Inductive systems can represent and learn from a wider range of feature types than either neural networks or pattern recognition. The ability to use richer feature sets for describing examples makes them at least as accurate and many time more precise. Case-Based Reasoning solves complex problems like planning, scheduling, and design by finding a similar, successful past plan, schedule, or design, and modifying it to meet the current problem's needs.

Another technology that can be added in a combinational approach is Fuzzy Logic. Fuzzy logic is able to account for areas that are not clearly defined. The logic can be extended to handle partial truths in situations where the answer lies somewhere in between what is true and what is false. Many of the big problems in organizations cannot be solved by simple yes/no or black/white programming answers. Sometimes answers come in shades of gray, where fuzzy logic proves useful. Fuzzy logic handles imprecision or uncertainty by attaching various measures of credibility to propositions. Fuzzy technology enables clear definition of problems where imperfect or partial knowledge exists, such as when the goal is “about 12 years old” or between “all” and “nothing”. Traditional and classical logic typically categorize information into binary patterns such as: black/white, yes/no, true/false, or day/night.

The power of fuzzy logic is exponential when it is combined with other technologies like genetic algorithms, neural networks, and business rules. Many of the big problems in organizations cannot be solved by simple yes/no or black/white programming answers. Sometimes answers come in shades of gray, this is where fuzzy logic proves useful. Fuzzy logic handles imprecision or uncertainty by attaching various measures of credibility to propositions.

Genetic algorithms are able to address complicated problems with many variables and a large number of possible outcomes, by simulating the evolutionary process of “survival of the fittest” to reach a defined goal. They operate by generating many random answers to a problem, eliminating the worst and cross-pollinating the better answers. Repeating this elimination and regeneration process gradually improves the quality of the answers to an optimal or near-optimal condition. In computing terms, a genetic algorithm is a population of individuals represented by chromosomes, a set of character strings.

Genetic algorithms include three stages: building and maintaining a population of solutions to a problem, choosing the better solutions for recombination with each other, and using their offspring to replace poorer solutions. Each stage produces a new generation of possible solutions for a given problem.

In the first stage, an initial population of potential solutions is created as a starting point for the search process, each element of the population is encoded into a string (the chromosome), to be manipulated by the genetic operators. In the next stage, the performance (or fitness) of each individual of the population is evaluated with respect to the constraints imposed by the problem. Each individual of a population represents a possible solution to a given problem. Each individual is assigned a “fitness score” according to how good a solution to the problem it is. A potential solution to a problem may be represented as a set of parameters.

Business Rules, or Expert Systems are the most widely used commercial applications developed using artificial intelligence (AI). Many use expert systems to solve business problems. Expert systems model information at a higher level of abstraction. When these systems are implemented well they closely resemble human logic and become more reliable and easier to maintain. The goal is for the expert system to apply heuristic knowledge to give advice or make recommendations just like a human expert. Rules are used to represent a rule-of-thumb to specify a group of actions performed for a given situation. Rules are composed of if-then statements that comprise the necessary solution. An inference engine automatically matches facts against patterns and automatically determines which rules are applicable. This process of selecting rules against historical patterns will continue to repeat itself until no applicable rules remain. It is critical that the knowledge source is reliable, because the system is only as good the knowledge assimilated into the rules. One of the most difficult tasks in developing an expert system is extracting the knowledge from an expert so the rules can be written. The most widely known algorithms for compiling rules are RETE and TREAT.

Data mining, or knowledge discovery, in databases is the nontrivial extraction of implicit, previously unknown and potentially useful information from data. It is the search for relationships and global patterns that exist in large databases but are hidden among the vast amount of data. Using particular classifications, association rules and analyzing sequences; data is extracted, analyzed and presented graphically. Data mining, or knowledge discovery in databases is the nontrivial extraction of implicit, previously unknown and potentially useful information from data. It is the search for relationships and global patterns that exist in large databases but are hidden among the vast amount of data. Using particular classifications, association rules and analyzing sequences, data is extracted, analyzed and presented graphically.

Data mining algorithms always requires a number of different technical approaches to address data cleaning, sampling, clustering, learning classification rules, analyzing changes and detecting anomalies.

Descriptive Statistics is the process of obtaining meaningful information from sets of numbers that are often too large to deal with directly. While it is often impossible to calculate scores for all models when searching a large model space, it is often feasible to describe and calculate scores for a few equivalent classes of models receiving the highest scores. Prediction methods for this sort of problem always assume some regularity in the probability distribution.

Real-time profiling keeps track of activities over windows time spanning seconds, minutes, hours, days, months or even years. These profiles can highlight suspicious changes in device activities, by looking at the number of transactions from a device over a window of time, histories of payment methods, typical purchasing from the device, patterns and clickstreams of the device at the merchant's site, e-mail address activity from the device, ship-to and bill-to activity, etc.

Modern inventory control and retail checkout systems are capable of producing a lot of statistics about purchase behaviors of single individuals on a single visit and group behaviors over an hour, day, week, month, etc. These statistics can provide important insights into what consumers buy, what they buy in combination, and any correlations to time of day, day of week, month or year. They can also provide statistics on how a particular transaction fits within a larger group of transactions.

The place of purchase will be inherent in the statistics that can be collected. People tend not to venture very far from home or world and a retail merchant offering incentives would do well to offer their incentives in the neighborhoods where the targeted consumers are active. The widespread use of credit cards, payment cards, loyalty cards, and personal mobile devices allows a payments processor to tie seemingly unrelated purchase transactions together by the behavior of the consumer and even the device ID information obtainable from their browsings and log ons.

For example, payments transaction records can show where a particular consumer has been shopping and when they most frequently shop, and what they shop for, e.g., groceries, gasoline, clothes, cars, etc. Patterns will often emerge that can be analyzed to forecast when and where the next shopping trip will be and what for. An enrolled merchant can benefit from the SaaS product services described herein by being able to send the consumer a coupon or message that the consumer would find of interest and timely.

Smart analytics embodiments of the present invention analyze consumer transaction data to help merchants deliver productive messages to their customers and prospects according to their particular, life stages, interests, geography, spending patterns, seasonal, culture, and other differentiating characteristics that can influence what they buy.

FIG. 1 illustrates a payment processor 102 and Internet web portal connected to service routine transactions coming from thousands of merchants and millions of shoppers. A software-as-a-service (SaaS) 100 is used to augment and enhance the consumer transaction services, it is used to sign up merchants. SaaS 100 controls what features these merchants will have access to. For example, the merchants access the portal to collect insights into their customers' motivations and identify potential new customers from database 120. A principal goal is to help merchant computers artificially “understand” their customers as non-homogenous individuals. This enables the merchants to make smarter decision about customer needs and future behaviors to proactively formulate attractive and personalized commercial offers.

SaaS 100 helps merchants identify where their best customers will spend their money, and then assist in directing their efforts accordingly.

Given the perspective SaaS 100 would have in servicing thousands of independent merchants, it could effectively provide useful peer view analyses. E.g., to provide marketing awareness and assistance for comparable merchants within a local geographic area.

As each consumer user shops in real-time and adds to their shopping carts it becomes possible to execute a Market Basket Analysis to spot further revenue optimization opportunities. For example, Up-sell and cross-sell offers by creating a group of items often bought together, e.g., bagels, cream cheese, cumber, onion, smoked salmon, and capers. Or things bought sequentially over days or weeks, e.g., engagement ring, wedding ring, wedding arrangements, honeymoon vacation spots. Loyalty programs can be based on advanced association methods. Such as to reward new and loyal customer with offers that they want and will redeem at the point-of-sale in real-time.

The spending habits of customers can be followed in each individual store, across a chain, and the user specific advertisement data can then be customized and adjusted based on user profiles and/or the current clickstreams.

### Horizontal/Vertical Browsing

Real-time coupon redemption can be offered at the point of interaction. Offers can be limited to those with a short distance to the point-of-service. Clickstream analysis for Card Not Present transaction can help to understand how online shoppers navigate through a web site. The information can be used to customize and adjust user-specific advertisement data. Recommendation can be made by SaaS 100 on how to best optimize the merchant websites' workflows.

SaaS 100 can help with Inventory Management/Supply Chain disruptions. E.g., to eliminate the expense of stock-outs and overstocks. Weather, season, weekend, before and after taxes, events, etc., can all play a role that are predictable by analyzing user behaviors. SaaS 100 is useful in Store Operation and Store Organizations to monitor: Product, Placement, Pricing and Promotion and to understand how they impact volume growth or decline within a brand or category. Seasonal Product Placement requires putting the right product in the right place at the right price at the right time.

Conventional marketing strategies can therefore be applied in very practical ways with very affordable computer tools and systems. For example using, demographic baskets (clustering, family), competitor stores, comparative store sales, front store sales, inventory turnover, labor cost analysis register usage analysis, cross-selling, location-based marketing, in-store behavior analysis, customer micro-segmentation, leverage, if available, data in social media to drive effective promotions, collaborative filtering to generate “you might also want” prompts for each product bought or visited, behavioral device identification for security, and offers based on behavioral device activities and shopping patterns of a specific device.

Individual words collected in the clickstreams flowing back to SaaS 100 can often be highly ambiguous, and specific meanings for them need to calculated. This can be done by a computer by analyzing the contexts in which the words exist. Context vectors and weights are assigned by the computer to artificially resolve word ambiguities. The points of interest for the consumer are revealed, and are used as a template to screen through appropriate commercial messages given the individual consumers' apparent shopping interests.

A diverse kit of commercial messages are sold to and subscribed by a wide variety of commercial producers of products and services. These commercial producers will pay a premium for SaaS services that can effectively deliver a relevant audience. Such is therefore a principal object of the present invention, to profit by selling such a service.

What a user is looking for can be artificially understood by a computing machine using context information. The context a user is working from or into can be engaged to tune or filter the offers an artificial intelligence machine makes to end users. The context can be gleaned from the way the users are navigating webpages. Clues are hinted their search keywords as to their particular culture, geography, age, preferences, and sensibilities. Understanding the context of the users' search keywords and items the users click on can work like constraints to display increasingly more appropriate content.

It seems as though all words are ambiguous in that they have many different meanings and even products can have many different uses and purposes. A computing machine cannot naturally resolve such ambiguities, but humans do it instantly and effortlessly. Consider the words, “apple”, “attack” and movie, and the corresponding contexts each can employ.

| WORD | CONTEXTS POSSIBLE |
|---|---|
| apple | computer, hardware, software, laptop, servers, |
| | PowerBook, iMac, iBook, ClarisWorks, AppleWorks, |
| | PowerMac, Steve Jobs, acquisitions, alliances, |
| | New York Times, TheStreet.com, Adam's apple, |
| | Fruit, New York, Computer, Red, Green, Delicious, |
| | Apple Custard, Apple Sauce, Crab Apple, Apple |
| | Butter, Apple Pie, Apple chips, Apple juice, |
| | Apple cider, industry analysis, price, or volume |
| | movement |
| attack | violence, sports, heart, war, game, illness, |
| | chemical, or agent |
| movie | fun, film, cinema, cinematic, cinematograph, |
| | feature, flick, motion picture, moving picture, |
| | photoplay, screenplay, show, silent, silver |
| | screen, talkie, talking picture, videotape, |
| | theater, or entertainment |

Similarly, things, items, services, and products can have several purposes, only one of which the user will put it to. Consider the following for “patent”, “kerosene”, and “acetone”.

| ITEM | PURPOSES POSSIBLE |
|---|---|
| patent | legal protection, prestige, credibility, |
| | tangible asset, bragging rights, market |
| | monopoly, scientific publication, legacy, land |
| | deed, or to mean “on its face” as an adjective |
| kerosene | engine fuel, jet fuel, lighting, heating, |
| | cleaning, dissolving, reducing, or low |
| | volatility fire |
| acetone | nail polish remover, paint cleaner, solvent, |
| | paint thinner, or as in a acetone cyanohydrin |
| | precursor to methyl methacrylate |

A method embodiment of the present invention parses each webpage or URL into its relevant words. Contextual weights are assigned to each extracted word according to how each is displayed in the electronic document. A context vector is created for each extracted word and the contexts taken from a thesaurus database. A weight vector is associated with a context vector for each relevant word. The highest weighted vectors point to the most important contexts. A check is made to see if the current interests of the user are in line with a stored profile for them. If not, a new profile is created. If so, then the users′; “likes” are reinforced. Both are then used to constrain the launching any ads to just the ones that target the current profile.

### Sample Webpage

Breast Cancer Symptoms

Early breast cancer usually does not cause pain. In fact,

when breast cancer first develops, there may be no symptoms at
all. But as the cancer grows, it can cause changes that women
should watch for:

A lump or thickening in or near the breast or in the

underarm area.

A change in the size or shape of the breast.
A discharge from the nipple.
A change in the color or feel of the skin of the

breast, areola, or nipple (dimpled, puckered, or scaly).

A woman should see her doctor if she notices any of

these changes. Most often, they are not cancer, but only a
doctor can tell for sure.

The relevant words are “breast”, “cancer”, “doctor”, and “symptoms”.

### Relevant Words Assigned Context Vectors and Weighted

| WORD | CONTEXT VECTOR | WEIGHT VECTOR |
|---|---|---|
| breast | (mammary, glands, nipple, cancer) | (1, 1, 4, 10) |
| cancer | (disease, doctor, breast cancer) | (1, 2, 5) |
| doctor | (physician, hospital, patient, disease) | (1, 1, 1, 1) |
| symptoms | (disease, doctor, patient) | (1, 1, 1) |

So, “breast” has a vector weighted most toward “cancer”. “Cancer” has a vector weighted most toward “breast cancer”. And “doctor” and “symptoms” have no obvious preferred context.

Limiting marketing efforts to those that are audience appropriate will optimize the experience and the benefits for both the company making the offers and the user/buyer. Ads that are relevant to the users seeing them are more likely to generate sales.

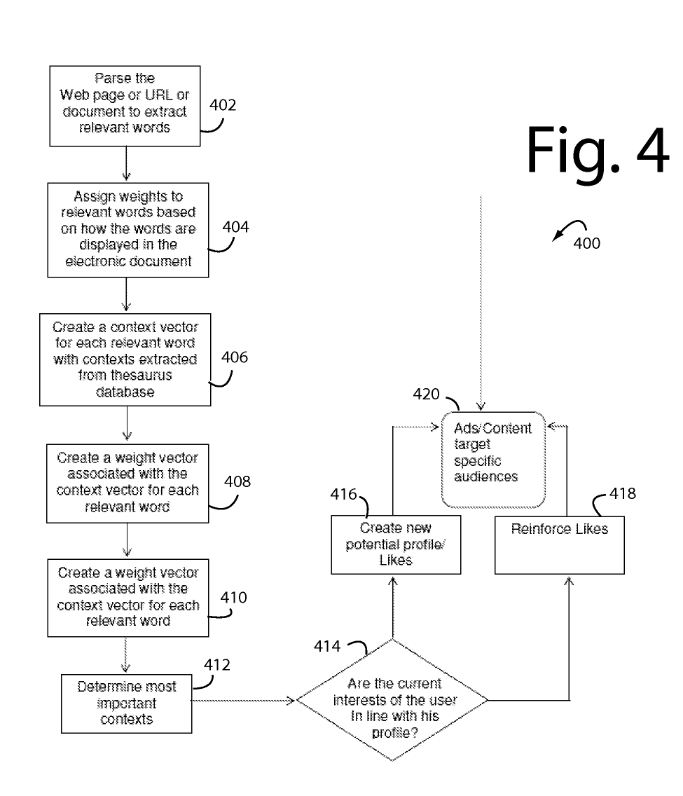

FIG. 4 represents a method 400 for artificial understanding of webpage content. A step 402 parses a Web page, URL, or document to extract its significant, relevant words. A step 404 assigns weights to these words based on how the words are arranged in the electronic document. A step 406 creates a context vector for each selected word with their contexts extracted from a thesaurus database. A step 408 creates weight vectors that are associated with the corresponding context vectors for each relevant word. A step 410 creates a weight vector associated with the context vector for each relevant word. A step 412 determines which contexts appear to be the most important. A step 414 asks if the current interests of the user appear to be in-line with their current profile? If not, a step 416 creates new potential profile of “likes” and preferences. If so, a step 418 reinforces the likes and preferences already on file. A step 420 formulates productive ads and content designed to target specific, identified audiences.

Consumer and user behaviors can have multi-dimensional ranges that can be quantified and contributed to database 120 to identify them as individuals and to follow their travel, spending, shopping, seasonal, event related, and “likes”.

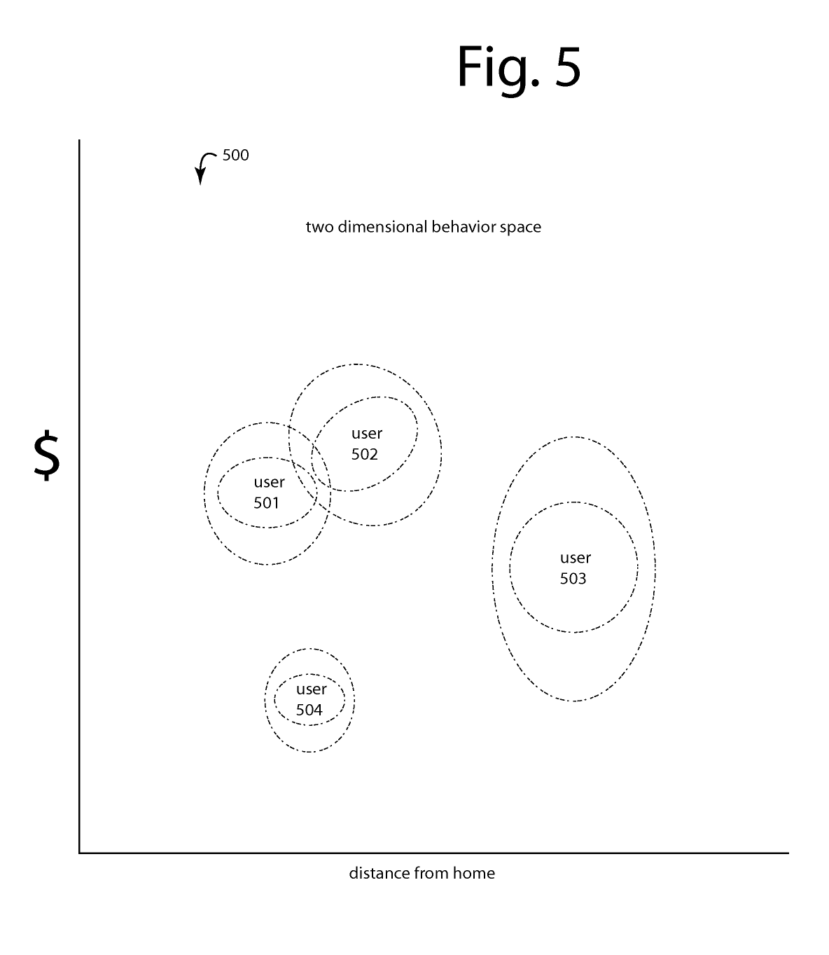

We are limited here in our Disclosure to providing two dimensional illustrations of user behaviors, such as in FIG. 5 where the amount of money ($) spent in a past series of transactions is plotted in a graph 500 against how far from home the transactions occurred. Users 501-504 will differ in these two dimensions, as well as dozens of other simultaneous dimensions. But this illustration, FIG. 5, will help put our point across. Looking at graph 500, it can be seen that each user has inner and outer bounds that encircle each. The inner bounds are drawn around normal, not unusual behaviors. Occasionally a transaction may plot outside the inner boundary but still inside the outer boundary. Such a transaction warrants further investigation and security factor collection if a transaction authorization is at hand. Or, it may signal a new preference for the particular user. Transactions that plot outside the outer boundary warrant alarms and invention.

Referring to FIG. 5, it is normal for user 501 to venture out less distantly than users 502-504, but still user 501 will typically spend more than user 504. User 503 has the widest range of normal behaviors in these dimensions, and user 504 has the tightest range.

The many other simultaneous dimensions that can be included in user behavior space run the gambit of time-of-day, day-of-week, days-before-holiday, coupon redemption correlations, merchant-by-category, products strongly associated with adult/juvenile men/women, etc.

The engineering of a system that builds the data from transactional information user-by-user and that does boundary monitoring in multi-dimensional spaces is expected to be straightforward for any artisan in this field and a detailed description of how to construct the pieces seems unnecessary here.

Although particular embodiments of the present invention have been described and illustrated, such is not intended to limit the invention. Modifications and changes will no doubt become apparent to those skilled in the art, and it is intended that the invention only be limited by the scope of the appended claims.

1. A computer program product for centralized hosting of business applications, comprising software instructions for enabling a payments processor network server to:
monitor consumer purchase transaction and payment data independently communicated with individual merchant transaction servers and a payments processor server;
identify individual consumers from many instances of consumer purchase transaction and payment data coming over time over many unrelated connections to independent merchant transaction servers;
collect and organize consumer purchase information derived from the transaction and payment data according to the consumer identities recognized;
characterize what is important to each identified consumer and forecast what they are likely to buy from intimations obtainable from records of what they did buy, when they bought it, what was bought in combination, where it was bought, what the total purchases were, and any strong correlations to other available data;
enroll individual ones of many merchant transaction servers connected to the payments processor server to access conclusions calculated as to what is important to each identified consumer and forecasts of what they are likely to buy; and
service real-time requests by enrolled ones of the merchant transaction servers for said conclusions;
wherein, enrolled ones of the merchant transaction servers are enabled by said conclusions to offer messages and incentives of interest to a correspondingly identified consumer at the time of their concluding another transaction with a merchant.

2. The computer program product of claim 1, further comprising software instructions for enabling a payments processor network server to:
analyze past payments transaction records to build statistics related to where a particular consumer has been shopping and when they most frequently shop, and what they shop for;
wherein, patterns in the shopping behavior are analyzed to forecast when and where a next shopping trip will occur and what will be bought;
wherein, an enrolled merchant can benefit from a SaaS product service by being able to send the consumer a coupon or message that the consumer would find of interest and timely.

3. A software-as-a-service (SaaS) computer program product for enabling a payments processor network server to gather consumer transaction data and to return suggestions and insights to subscribing merchants on how to specifically constrain their commercial offers to particular shoppers, the SaaS including software instruction sets to:
compute an artificial understanding of webpage content;
parse a Web page, URL, or document to extract its significant, relevant words;
assign weights to these words based on how the words are arranged in an electronic document;
fashion a context vector for each selected word with their contexts extracted from a thesaurus database;
generate weight vectors that are associated with the corresponding context vectors for each relevant word;
compute a weight vector associated with the context vector for each relevant word;
determine which contexts are the most important;
ask if the current interests of the user are in-line with their current profile, and if not, create new potential profile of “likes” and preferences, and if so, reinforce any likes and preferences already on file; and
formulate productive ads and content designed to target specific, identified audiences.

4. The SaaS product of claim 3, further comprising software instruction sets to:
identify consumer and user behaviors with multiple dimensions and ranges that can be quantified and contributed to a database to thereafter identify them as individuals and to follow their travel, spending, shopping, seasonal, event related, and “likes”.
